(19) United States
(12) Patent Application Publication
(10) Pub. No.: US 2017/0159790 A1
(43) Pub. Date: Jun. 8, 2017

(54) Concentric Camshaft and Method of Manufacturing Rotatable Cam and Fixed Cam for Concentric Camshaft

(71) Applicant: SEOJINCAM CO., LTD., Pyeongtaek-si, Gyeonggi-do (KR)

(72) Inventors: Yong Kyoon KIM, Suwon-si, Gyeonggi-do (KR); Yung Sang PARK, Pyeongtaek-si, Gyeonggi-do (KR); Jun Ho SONG, Pyeongtaek-si, Gyeonggi-do (KR); Keun Ho KANG, Osan-si, Gyeonggi-do (KR); Jong Hun SONG, Bucheon-si, Gyeonggi-do (KR)

(21) Appl. No.: 15/324,410

(22) PCT Filed: May 28, 2015
(86) PCT No.: PCT/KR2015/005328

§ 371 Date: Jan. 6, 2017

(30) Foreign Application Priority Data
Jul. 10, 2014 (KR) 10-2014-0086866

(51) Int. Cl. F16H 53/02; B21D 53/84; B23K 20/02; F01L 1/047

(52) U.S. Cl. CPC F16H 53/025; F01L 1/047; B21D 53/845; B23K 20/02; F01L 2001/0473; F01L 2103/00

(57) ABSTRACT

Provided is a concentric camshaft and a method of manufacturing the same, in which at least one of a fixed cam and a rotatable cam is a sintered cam configured to fix the cam and an inner piece through diffusion bonding, capable of reducing a machining amount, simplifying a manufacturing process because a heat treatment process for improving cam surface hardness is unnecessary, and being applied to an engine having a small space because the weight is reduced through a weight-reducing structure of a surface of the cam and a width of the inner piece is reduced.

### TECHNICAL FIELD

The present invention relates to a concentric camshaft and a method of manufacturing the same, and more particularly, to a concentric camshaft and a method of manufacturing the same, in which at least one of a fixed cam and a rotatable cam is a sintered cam configured to fix the cam and an inner piece through diffusion bonding.

### BACKGROUND ART

A concentric camshaft of the related art is disclosed in US Patent Application Publication Nos. 2012-0260873 and 2010-0170458.

In US Patent Application Publication Nos. 2012-0260873 and 2010-0170458, a pin fixing section expanded in an axial direction is provided to fix a rotatable cam to a shaft using a pin. The cam is integrally formed through forging or round bar machining.

However, in the manufacturing method of the related art, a round bar including a can and a pin fixing section should be processed, and thus an amount of waste materials is increased. In addition, in order to increase surface hardness after manufacture, separate surface heat treatment should be performed.

In addition, in the manufacturing method of the related art, in order to improve workability during forging, a gradient is needed at a boundary between the cam and the pin fixing section to cause an increase in weight due to unnecessary reinforcement. Further, since the pin fixing section should have a certain width or more, compact parts cannot be provided.

### DISCLOSURE OF INVENTION

### Technical Problem

In order to solve these problems, the present invention is directed to provide a concentric camshaft and a method of manufacturing the same that are capable of reducing a machining amount by applying a sintered cam in which at least one of a fixed cam and a rotatable cam is fixed to an inner piece through diffusion bonding, simplifying a manufacturing process because a heat treatment process for improving cam surface hardness is unnecessary, and being applied to an engine having a small space because the weight is reduced by applying a weight-reducing structure to the cam surface and a width of the inner piece is reduced.

### Solution to Problem

In order to accomplish the above-mentioned aspect, the present invention provides a method of manufacturing a rotatable cam for a concentric camshaft, the method including: separately forming and preparing an inner piece having a hollow section which is rotatable with respect to an outer shaft, and a rotatable cam piece fixed to the inner piece; and coupling the rotatable cam piece to the inner piece, wherein, in the coupling, the rotatable cam piece is fixed to the inner piece through diffusion bonding.

In order to accomplish the above-mentioned aspect, the present invention also provides a method of manufacturing a fixed cam for a concentric camshaft, the method including: separately forming and preparing an inner piece having a hollow section through which an outer shaft is inserted, and a fixed cam piece fixed to the inner piece; and coupling the fixed cam piece to the inner piece, wherein, in the coupling, the fixed cam piece is fixed to the inner piece through diffusion bonding.

In order to accomplish the above-mentioned aspect, the present invention also provides a concentric camshaft including: a fixing section provided with an outer shaft having a long hole and a fixed cam fixed to an outer circumferential surface of the outer shaft; and a rotatable section provided with an inner shaft inserted into the outer shaft, a rotatable cam disposed outside the outer shaft, and a pin configured to connect the rotatable cam and the inner shaft and inserted into the long hole, wherein at least one of the fixed cam and the rotatable cam is fixed to an inner piece disposed outside the outer shaft through diffusion bonding.

In addition, the rotatable cam may have a second through-hole through which the inner piece is inserted, and a groove may be formed in a side section of the rotatable cam to be in communication with the second through-hole.

In the above-mentioned configuration, the pin may be constituted by a spiral spring, the rotatable cam may be fixed to the inner piece through diffusion bonding, and a first key groove into which the pin is inserted may be formed at the inner piece to be opened at one side.

### Advantageous Effects of Invention

According to the concentric camshaft and the method of manufacturing the same as described above, the following effects will be provided.

The cam and the inner piece are fixed through diffusion bonding to reduce a machining amount, the manufacturing process is simplified because a heat treatment process for improving cam surface hardness is unnecessary, and the camshaft can be applied to an engine having a small space because the weight of the cam and a width of the inner piece can be reduced.

Wearing resistance requirements of the inner piece that repeatedly slides against the outer shaft are satisfied and the parts are separately machined and coupled to minimize an amount of waste during machining. Accordingly, the machining time is reduced and the parts can be formed of a material having optimal physical properties, thereby maximizing durability and minimizing manufacturing cost.

The rotatable cam may have the weight-reducing structure such as the second through-hole through which the inner piece is inserted, and the groove formed in the side section of the rotatable cam and in communication with the second through-hole.

The pin of the concentric camshaft is constituted by the spiral spring, and the pin can be securely fixed due to an elastic force after installation of the pin.

The first key groove into which the pin is inserted is formed at the inner piece to be opened at one side, press-fitting of the pin can be improved, and a width of the inner piece can be further reduced.

### BRIEF DESCRIPTION OF DRAWINGS

FIG. 1 is a partial perspective view showing a concentric camshaft according to a first embodiment of the present invention;

FIG. 2 is a cross-sectional view of FIG. 1;

FIGS. 3 to 7 are partial cross-sectional views showing various concentric camshafts according to a second embodiment of the present invention;

FIG. 8 is an exploded perspective view showing assembly of the concentric camshaft according to the second embodiment of the present invention;

FIG. 9 is a view showing an assembled state of the concentric camshaft according to the second embodiment of the present invention; and

FIG. 10 is a view showing an assembled state of a concentric camshaft according to a third embodiment of the present invention.

### MODE FOR THE INVENTION

Hereinafter, exemplary embodiments of the present invention will be described below in detail with reference to the accompanying drawings.

For reference, the above-mentioned related art will be referred to regarding the components of the present invention that are the same as those of the related art, and detailed description thereof will be omitted.

### First Embodiment

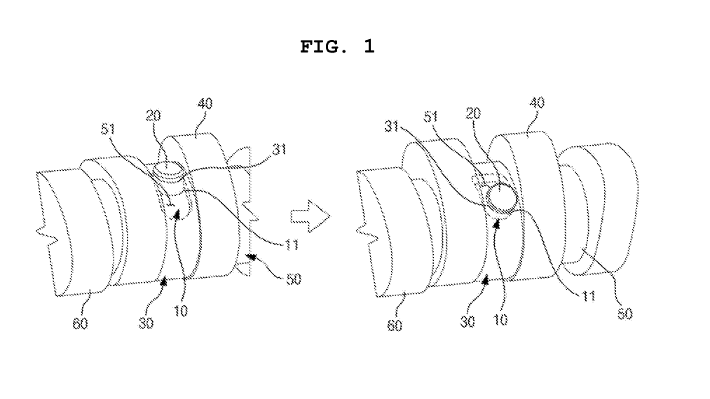

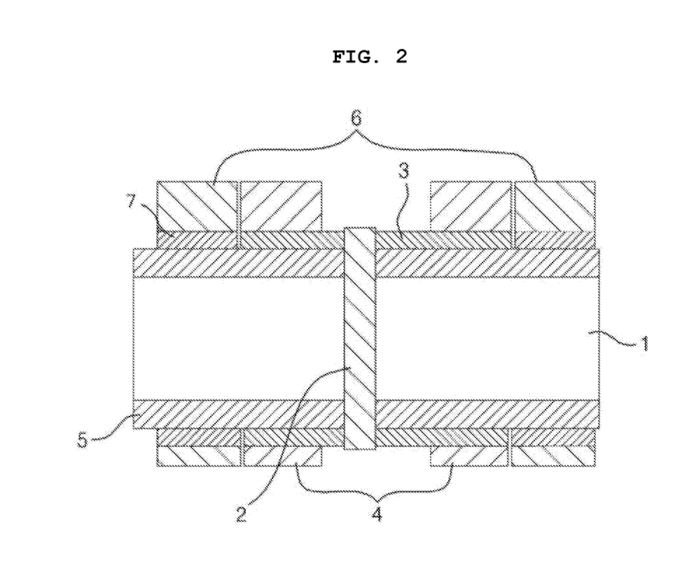

As shown in FIGS. 1 and 2, a concentric camshaft of a first embodiment includes a fixing section provided with an outer shaft 50 having a long hole 51 and a fixed cam 60 fixed to an outer circumferential surface of the outer shaft 50; and a rotatable section provided with an inner shaft 10 inserted into the outer shaft 50, a rotatable cam 40 disposed outside the outer shaft 50, and a pin 20 configured to connect the rotatable cam 40 and the inner shaft 10 and inserted into the long hole 51, wherein at least one of the fixed cam 60 and the rotatable cam 40 is fixed to inner pieces 30 and 70 disposed outside the outer shaft 50 through diffusion bonding.

The fixing section includes the outer shaft 50 having the long hole 51, and the fixed cam 60 fixed to the outer circumferential surface of the outer shaft 50.

The outer shaft 50 is a pipe in which a first hollow section is formed, and the long hole 51 in communication with the first hollow section is formed in the circumferential direction.

The plurality of long holes 51 may be formed and disposed in the longitudinal direction of the outer shaft 50.

The fixed cam 60 is preliminarily formed by compressing a metal powder. A first through-hole through which the inner piece 70 is inserted is formed in the fixed cam 60.

The inner piece 70 is disposed outside the outer shaft 50. The inner piece 70 has a ring shape and is formed to have the same width as the fixed cam 60.

The fixed cam 60 is fixed to the inner piece 70 through diffusion bonding. Accordingly, the inner piece 70 is disposed between the fixed cam 60 and the outer shaft 50.

The inner piece 70 is fixed to the outer shaft 50 through hot-fitting or press-fitting, and the fixed cam 60 is fixed to the outer shaft 50.

The plurality of fixed cams 60 are disposed to approach the long holes 51.

The fixed cams 60 may be a plurality of cams having different lifts and integrally formed with each other. In addition, cam lobes of the plurality of cams integrally formed with each other may be alternately formed.

The rotatable section includes the inner shaft 10 inserted into the outer shaft 50, the rotatable cam 40 disposed outside the outer shaft 50, and the pin 20 configured to connect the rotatable cam 40 and the inner shaft 10 and inserted into the long hole 51.

The rotatable section is rotated about a shaft disposed with respect to the fixing section in the longitudinal direction.

The inner shaft 10 is a solid shaft, and inserted into the first hollow section of the outer shaft 50. An outer diameter of the inner shaft 10 is smaller than an inner diameter of the outer shaft 50.

A second key groove 11 is formed to pass through the inner shaft 10 in a widthwise direction. The second key groove 11 is in communication with the long hole 51.

A second through-hole through which the inner piece 30 is inserted is formed in the rotatable cam 40.

The inner piece 30 is disposed outside the outer shaft 50. Accordingly, the inner piece 30 is disposed between the rotatable cam 40 and the outer shaft 50.

A second hollow section is formed in the inner piece 30, and the outer shaft 50 is inserted into the second hollow section. The inner piece 30 disposed between the rotatable cam 40 and the outer shaft 50 is slidable (rotatable) with respect to the outer shaft 50.

The inner piece 30 is formed of carbon steel such as S45C.

A first key groove 31 is formed to pass through the inner piece 30 in a widthwise direction. The first key groove 31 is in communication with the long hole 51 and the second key groove 11.

The first key groove 31 is formed not to be opened at one side (in a longitudinal direction of the inner piece 30).

Two rotatable cams 40 may be provided to be fixed to both ends of the inner piece 30. The first key groove 31 is disposed between the two rotatable cams 40.

The rotatable cam 40 is preliminarily formed by compressing a metal powder.

The rotatable cam 40 is fixed to the inner piece 30 through diffusion bonding.

Accordingly, a corner between the rotatable cam 40 and the inner piece 30 forms a right angle.

The pin 20 has a round bar shape, passes through the long hole 51, and is press-fitted into the first and second key grooves 31 and 11 having a circular shape.

Hereinafter, a method of manufacturing the concentric camshaft having the above-mentioned configuration will be described.

The rotatable section and the fixing section are prepared by the following method.

A method of manufacturing a rotatable cam includes separately forming and preparing an inner piece 3 having a second hollow section which is rotatable with respect to an outer shaft 5 and a rotatable cam piece 4 fixed to the inner piece 3, and coupling the rotatable cam piece 4 to the inner piece 3, wherein, in the coupling, the rotatable cam piece 4 is fixed to the inner piece 3 through diffusion bonding.

The inner piece 3 is prepared to have a shape similar to or the same as that of the final inner piece 30 by machining the material.

The rotatable cam piece 4 is preliminarily formed by compressing a metal powder.

After inserting the inner piece 3 into the rotatable cam piece 4, the rotatable cam piece 4 is fixed to the inner piece 3 through diffusion bonding.

After the coupling step, the inner piece 3 and the rotatable cam piece 4 can be further machined.

An inner diameter of the inner piece 3 is larger than an outer diameter of the outer shaft 5.

A method of manufacturing a fixed cam includes separately forming and preparing an inner piece 7 having a hollow section into which the outer shaft 5 is inserted and a fixed cam piece 6 fixed to the inner piece 7, and coupling the fixed cam piece 6 to the inner piece 7, wherein, in the coupling, the fixed cam piece 6 is fixed to the inner piece 7 through diffusion bonding.

The inner piece 7 is prepared to have a shape similar to or the same as that of the final inner piece 70 by machining the material.

The fixed cam piece 6 is preliminarily formed by compressing a metal powder.

After inserting the inner piece 7 into the fixed cam piece 6, the fixed cam piece 6 is fixed to the inner piece 7 through diffusion bonding.

After the coupling, the inner piece 7 and the fixed cam piece 6 can be further machined.

The inner piece 7 is fixed to the outer shaft 5 through hot-fitting or press-fitting.

An inner diameter of the inner piece 7 is smaller than an outer diameter of the outer shaft 5.

The prepared rotatable section is assembled to the fixing section as will be described below.

The inner piece 7 fixed to the fixed cam piece 6 is press-fitted into the outer shaft 5, and the inner piece 3 fixed to the rotatable cam piece 4 is loosely inserted thereinto. As described above, the fixed cam piece 6 and the rotatable cam piece 4 are alternately inserted into the outer shaft 5.

An inner shaft 1 is inserted into the outer shaft 5, and a long hole and first and second key grooves coincide with each other to be in communication with each other. A pin 2 is press-fitted into the long hole and the first and second key grooves to complete the assembly.

### Second Embodiment

Detailed description and illustration of the same configuration as the above-mentioned embodiment will be omitted.

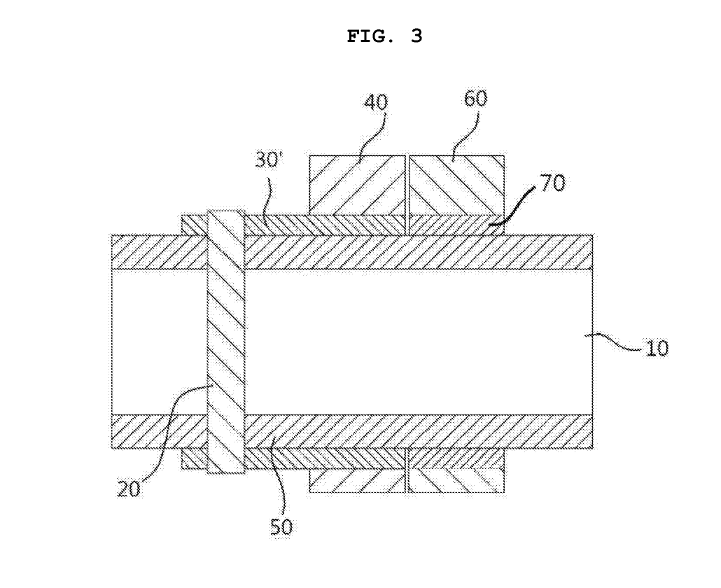

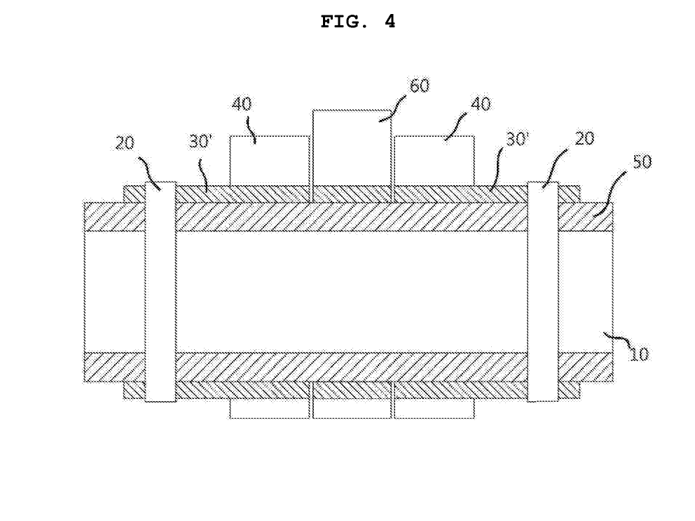

As shown in FIGS. 3 to 9, in a concentric camshaft according to a second embodiment, the rotatable section has one rotatable cam 40 fixed to one inner piece 30′.

The rotatable section may be disposed at one side of the one fixed cam 60 or may be disposed at both sides of the one fixed cam 60.

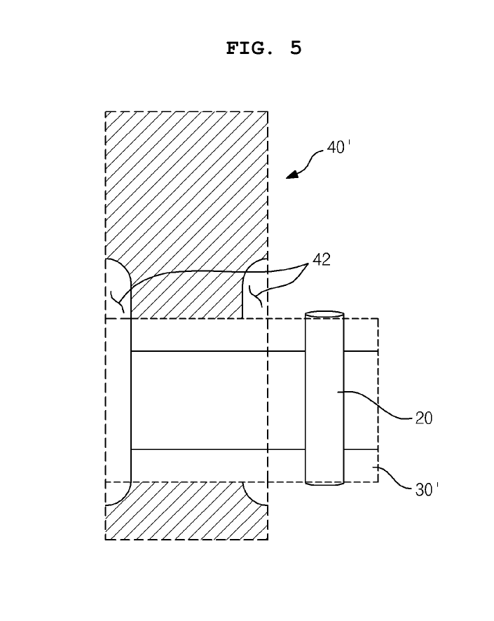

In addition, as shown in FIGS. 5 to 7, side sections (one side or both sides) of the rotatable cam 40 are reduced in weight, and grooves 42′ and 42 are formed at one side or both sides. The grooves 42′ and 42 are formed to be in communication with the second through-hole. The side sections are surfaces disposed at both sides perpendicular to the axis of the rotatable cam 40.

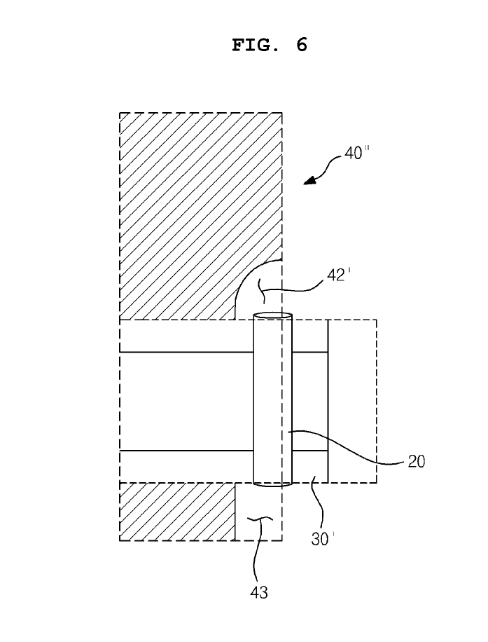

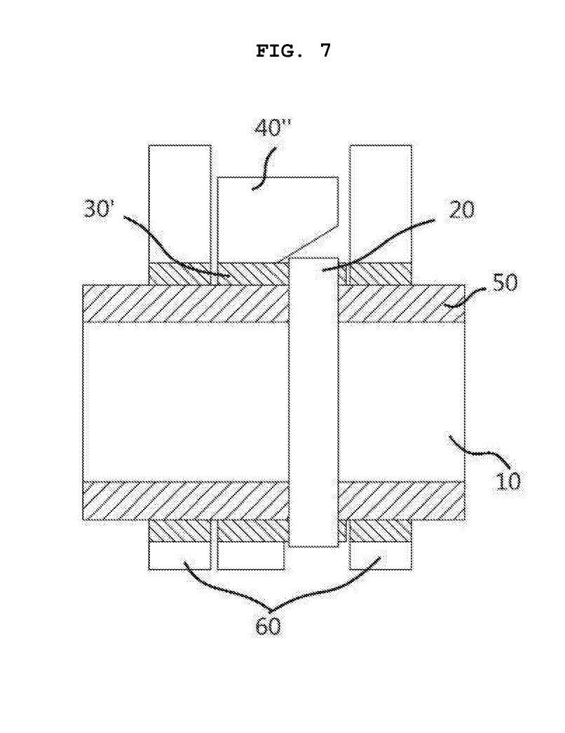

Further, as shown in FIGS. 6 and 7, the groove 42′ formed at one side may have an opening section 43 formed at a lower portion thereof. The opening section 43 is in communication with the first key groove 31.

Since the pin 20 can be press-fitted into the first key groove 31 of the inner piece 30′ through the opening section 43 of the rotatable cam 40, a length of the inner piece 30′ can be minimized. That is, the pin 20 is disposed in the groove 42′.

The rotatable section may be disposed between the two fixed cams 60.

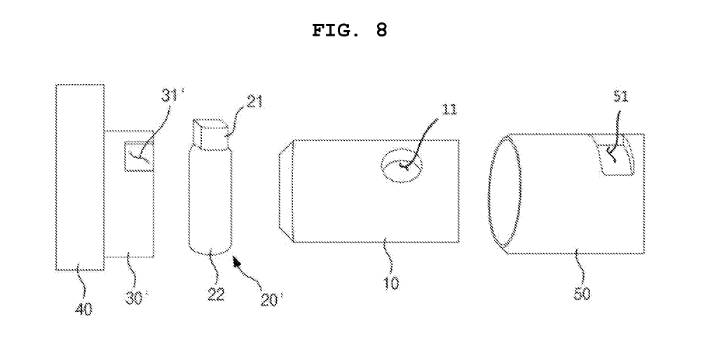

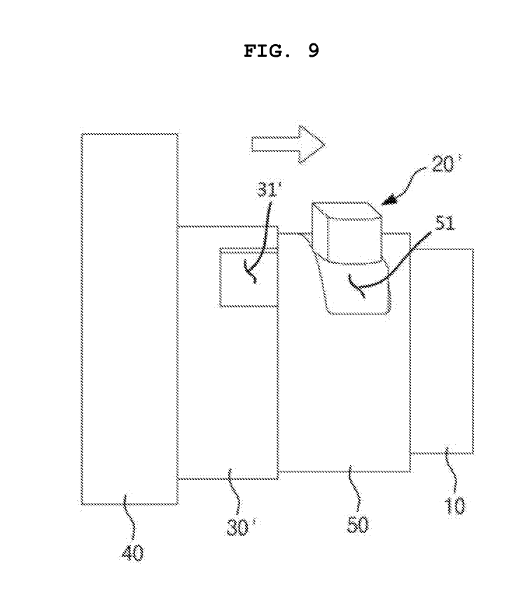

Meanwhile, as shown in FIGS. 8 and 9, a first key groove 31′ maybe formed to be opened at one side (in the longitudinal direction of the inner piece 30′). That is, the first key groove 31′ is opened in a direction of insertion into the outer shaft 50 when the inner piece 30′ is assembled.

In addition, the first key groove 31′ has a quadrangular (polygonal) shape.

An inner shaft insertion section 22 of a pin 20′ has a circular cross section, and an inner piece insertion section 21 has a quadrangular cross section.

When the first key groove 31′ is formed as described above, the inner shaft 10 is inserted into the outer shaft 50 to bring the long hole 51 in communication with the second key groove 11, and then the pin 20′ is press-fitted into the second key groove 11. Next, when the outer shaft 50 is inserted into the inner piece 30, the pin 20′ is simultaneously press-fitted into the first key groove 31′. As described above, the inner piece 30′ can be fixed to the inner shaft 10 through press-fitting using fastening of the pin 20′ and the inner piece 30′.

### Third Embodiment

Detailed description and illustration of the same configuration as the above-mentioned embodiment will be omitted.

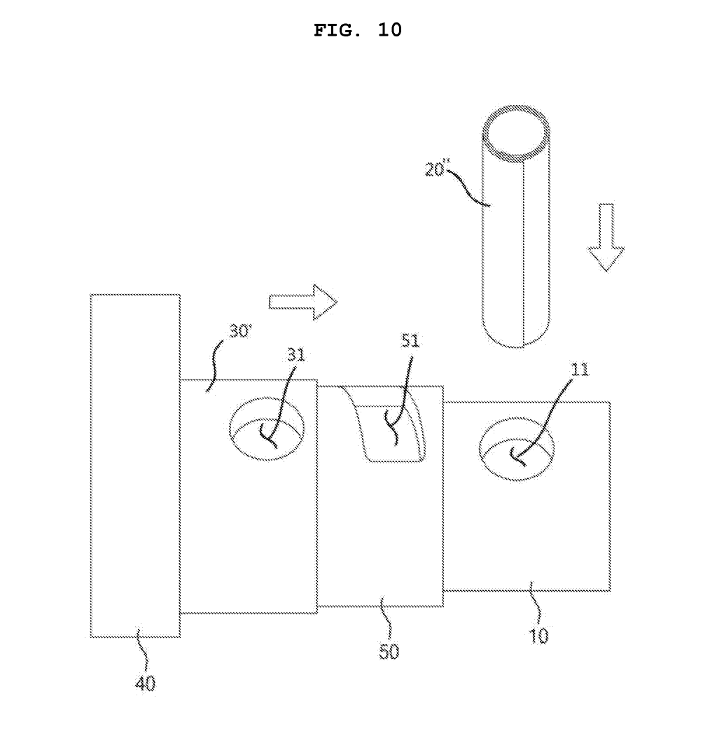

In a concentric camshaft according to a third embodiment, as shown in FIG. 10, a pin 20″ may include a spiral spring that can be elastically deformed. When the pin 20″ is formed of a spiral spring, an outer diameter of the pin 20″ can be elastically deformed to be reduced (contracted) upon press-fitting of the pin 20″ to easily press-fit the pin 20″, and the pin 20″ can be securely fixed due to a recovering force (expansion) of the elastically deformed pin 20″ after press-fitting of the pin 20″.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

1. A method of manufacturing a rotatable cam for a concentric camshaft, the method comprising:
separately forming and preparing an inner piece having a hollow section which is rotatable with respect to an outer shaft, and a rotatable cam piece fixed to the inner piece; and
coupling the rotatable cam piece to the inner piece,
wherein, in the coupling, the rotatable cam piece is fixed to the inner piece through diffusion bonding.

2. A method of manufacturing a fixed cam for a concentric camshaft, the method comprising:
separately forming and preparing an inner piece having a hollow section through which an outer shaft is inserted, and a fixed cam piece fixed to the inner piece; and
coupling the fixed cam piece to the inner piece,
wherein, in the coupling, the fixed cam piece is fixed to the inner piece through diffusion bonding.

3. A concentric camshaft comprising:
a fixing section provided with an outer shaft having a long hole and a fixed cam fixed to an outer circumferential surface of the outer shaft; and
a rotatable section provided with an inner shaft inserted into the outer shaft, a rotatable cam disposed outside the outer shaft, and a pin configured to connect the rotatable cam and the inner shaft and inserted into the long hole,
wherein at least one of the fixed cam and the rotatable cam is fixed to an inner piece disposed outside the outer shaft through diffusion bonding.

4. The concentric camshaft according to claim 3, wherein the rotatable cam has a second through-hole through which the inner piece is inserted, and a groove is formed in a side section of the rotatable cam to be in communication with the second through-hole.

5. The concentric camshaft according to claim 3, wherein the pin is constituted by a spiral spring.

6. The concentric camshaft according to claim 3, wherein the rotatable cam is fixed to the inner piece through diffusion bonding, and
a first key groove formed at the inner piece to be opened at one side into which the pin is inserted.
